(19) United States
(12) Patent Application Publication
(10) Pub. No.: US 2013/0323451 A1
(43) Pub. Date: Dec. 5, 2013

(54) Plasticized Polyoxymethylene

(71) Applicants: Oliver Jünger, Mainz (DE); Kirsten Markgraf, Weinheim (DE)

(72) Inventors: Oliver Jünger, Mainz (DE); Kirsten Markgraf, Weinheim (DE)

(73) Assignee: Ticona GmbH, Sulzbach (DE)

(21) Appl. No.: 13/879,307

(22) PCT Filed: Oct. 14, 2011
(86) PCT No.: PCT/EP11/67978

§ 371 Date: Aug. 23, 2013

(30) Foreign Application Priority Data
Oct. 14, 2010 (EP) 10187623.3

(51) Int. Cl. C08K 5/435

(52) U.S. Cl. CPC C08K 5/435
USPC 428/36.9; 524/590; 524/593; 524/512; 524/169

(57) ABSTRACT

The present invention relates to a molding composition, molded parts obtainable therefrom as well as the use of the molding composition for the manufacturing of molded parts used in the automotive industry, as well as for cables, pipes, tubes, corrugated pipes, fuel pipes, air pipes, fuel hoses, break hoses, air hoses, hydraulic hoses, pneumatic hoses, pressure hoses, and connection assemblies.

The present invention relates to a molding composition, molded parts obtainable therefrom as well as the use of the molding composition for the manufacturing of molded parts used in the automotive industry, as well as for cables, pipes, tubes, corrugated pipes, fuel pipes, air pipes, fuel hoses, break hoses, air hoses, hydraulic hoses, pneumatic hoses, pressure hoses, and connection assemblies.

The superior mechanical properties of polyoxymethylene (POM) molding compositions are the reason for their use in numerous applications. To improve their properties the polyoxymethylene homo- and copolymers are provided with additives to adapt the properties to the application of interest.

EP-A2-350 223 discloses a polyacetal resin composition comprising a polyacetal resin with a thermoplastic polyurethane which is prepared by melt-kneading in the presence of a polyisocyanate compound. The compositions may comprise 0.01 to 3 wt.-% of light stabilizer.

DE-A1-100 03 370 discloses polyoxymethylene compositions comprising an aliphatic thermoplastic polyurethane and 0.05 to 2 wt.-% of a stabilizer based on aromatic benzene derivatives.

There is a demand for flexible polyoxymethylene based molding compositions which are easy processable and which demonstrate a high impact resistance while being flexible and suitable for compression-loaded pipes, tubes or hoses.

Attempts to improve the flexibility of oxymethylene polymers by the addition of plasticizers was not sufficient. Likewise, the increase of the amount of comonomers, such as dioxolane could not sufficiently improve the flexibility. The object of the present invention is the provision of a polyoxymethylene based molding composition which are fuel resistant, flexible and which can be used for compression-loaded pipes, tubes and hoses. It is a further object to the present invention to provide a molding composition which is suitable for a blow molding and extrusion process, especially suitable for extrusion blow molding for the manufacturing of corrugated pipes.

It has been found that polyoxymethylene based molding compositions which demonstrate a sufficient flexibility and which can be used for the manufacturing of compression-loaded pipes, tubes and hoses can be obtained by compositions which comprise at least one polyoxymethylene, at least one plasticizer and at least one impact modifier.

An embodiment of the present invention is a molding composition comprising

a) at least one polyoxymethylene (A),
b) at least 1 wt.-% of at least one plasticizer (B),
c) at least one impact modifier (C) and
d) at least one coupling agent (D)
wherein the weight percent (wt.-%) is based on the total weight of the composition and wherein the composition has an E-modulus of less than 1500 MPa, determined according to ISO 527.

A further embodiment of the invention is a molding composition comprising
a) at least one polyoxymethylene (A),
b) 3.5 to 40 wt.-% of at least one plasticizer (B),
c) at least one impact modifier (C); and
d) at least one coupling agent (D).

### Component (A):

The molding composition according to the present invention comprises at least one polyoxymethylene (A) (hereinafter also referred to as “component (A)”). Component (A) of the molding composition according to the invention is a polyoxymethylene homo- or copolymer. Preferably, the polyoxymethylene (A) has a high content of terminal hydroxyl groups and more preferably contains no low molecular weight constituents or only a small proportion thereof. Polyoxymethylene (A) preferably has terminal hydroxyl groups, for example hydroxyethylene groups (—OCH₂CH₂—OH) and hemi-acetal groups (—OCH₂—OH). According to a preferred embodiment, at least 25%, preferably at least 50%, more preferably at least 75% of the terminal groups of the polyoxymethylene (A) are hydroxyl groups, especially hydroxyethylene groups.

The content of terminal hydroxyl groups and/or hydroxyl side groups (also referred to together as “terminal hydroxyl groups”) is especially preferred at least 80%, based on all terminal groups. Within the meaning of the present invention, the term “all terminal groups” is to be understood as meaning all terminal and—if present—all side terminal groups.

In addition to the terminal hydroxyl groups, the POM may also have other terminal groups usual for these polymers. Examples of these are alkoxy groups, formate groups, acetate groups or aldehyde groups. According to a preferred embodiment of the present invention the polyoxymethylene (A) is a homo- or copolymer which comprises at least 50 mol-%, preferably at least 75 mol-%, more preferably at least 90 mol-% and most preferably at least 95 mol-% of —CH₂O-repeat units.

It has been found that molding compositions which demonstrate an extremely high impact resistance can be obtained with a polyoxymethylene (A) which has low molecular weight constituents having molecular weights below 10,000 Dalton of less than 15% by weight, preferably less than 10% by weight, more preferably less than 5% by weight and most preferably less than 2% by weight, based on the total mass of the polyoxymethylene.

The “POM polymers” which can be used as polyoxymethylene (A) generally have a melt volume rate MVR of less than 50 cm³/10 min, preferably ranging from 1 to 20 cm³/10 min, more preferably ranging from 2 to 15 cm³/10 min and especially ranging from 4 to 10 cm³/10 min, e.g. 1 to 7 cm³/10 min determined according to ISO 1133 at 190° C. and 2.16 kg.

Preferably, polyoxymethylene (A) has a content of terminal hydroxyl groups of at least 5 mmol/kg, preferably at least 10 mmol/kg, more preferably at least 15 mmol/kg and most preferably ranging from 15 to 50 mmol/kg, especially 18 to 40 mmol/kg.

The content of terminal hydroxyl groups can be determined as described in K. Kawaguchi, E. Masuda, Y. Tajima, Journal of Applied Polymer Science, Vol. 107, 667-673 (2008).

The preparation of the polyoxymethylene (A) can be carried out by polymerization of polyoxymethylene-forming monomers, such as trioxane or a mixture of trioxane and dioxolane and/or butandiol formal in the presence of a molecular weight regulator such as ethylene glycol or methylal. The polymerization can be effected as precipitation polymerization or in particular in the melt. Initiators which may be used are the compounds known per se, such as trifluoromethane sulfonic acid, these preferably being added as solution in ethylene glycol to the monomer. The procedure and termination of the polymerization and working-up of the product obtained can be effected according to processes known per se. By a suitable choice of the polymerization parameters, such as duration of polymerization or amount of molecular weight regulator, the molecular weight and hence the MVR value of the resulting polymer can be adjusted. The criteria for choice in this respect are known to the person skilled in the art. The above-described procedure for the polymerization leads as a rule to polymers having comparatively small proportions of low molecular weight constituents. If a further reduction in the content of low molecular weight constituents were to be desired or required, this can be effected by separating off the low molecular weight fractions of the polymer after the deactivation and the degradation of the unstable fractions after treatment with a basic protic solvent.

This may be a fractional precipitation from a solution of the stabilized polymer, polymer fractions of different molecular weight distribution being obtained.

Preference is also given to polyoxymethylene (A) which also is obtainable by polymerizing polyoxymethylene forming monomers in the presence of heteropoly acids.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than 2% by weight.

The heteropoly acid is a generic term for polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

Hₓ[MₘM′ₙO_{z}]yH₂O

wherein
M represents an element selected from the group consisting of P, Si, Ge, Sn, As, Sb, U, Mn, Re, Cu, Ni, Ti, Co, Fe, Cr, Th and Ce,

M′ represents an element selected from the group consisting of W, Mo, V and Nb,

m is 1 to 10,
n is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are selected from the group consisting of phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof.

Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfils the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH₂)ₙ—(COOR′)

wherein
n is an integer from 2 to 12, preferably 3 to 6 and

R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)₂—CH—(CH₂)ₘ—CH—(COOR′)₂

wherein
m is an integer from 0 to 10, preferably from 2 to 4 and

R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Specific examples of the alkyl ester of a polybasic carboxylic acid are selected from the group consisting of dimethyl glutaric acid, dimethyl adipic acid, dimethyl pimelic acid, dimethyl suberic acid, diethyl glutaric acid, diethyl adipic acid, diethyl pimelic acid, diethyl suberic acid, diemethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 weight percent, preferably in an amount ranging from 0.01 to 5 weight percent, wherein the weight is based on the entire solution.

Further, polyoxymethylene (A) can also be a conventional oxymethylene homopolmyer and/or oxymethylene copolymer. As component (A) polyoxymethylenes are described for example in DE-A-2947490 which are generally unbranched linear polymers which contain as a rule at least 80%, preferably at least 90%, oxymethylene units (—CH₂—O—). As mentioned before, the term polyoxymethylenes comprises both, homopolymers of formaldehyde or its cyclic oligomers, such as trioxane or 1,3,5,7-tetraoxacyclooctane, and corresponding copolymers. For example the following components can be used in the polymerization process: ethyleneoxide, 1,2-propyleneoxide, 1,2-butyleneoxide, 1,3-butyleneoxide, 1,3-dioxane, 1,3-dioxolane, 1,3-dioxepane and 1,3,6-trioxocane as cyclic ethers as well as linear oligo- or polyformales, like polydioxolane or polydioxepane.

Further, functionalized polyoxymethylenes which are prepared by copolymerization of trioxane and the formal of trimethylolpropane (ester), of trioxane and the alpha, alpha and the alpha, beta-isomers of glyceryl formal (ester) or of trioxane and the formal of 1,2,6-hexantriol (ester) can be used as polyoxymethylene (A).

Such POM homo- or copolymers are known per se to the person skilled in the art and are described in the literature.

The molding composition of the present invention preferably comprises polyoxymethylene (A) in an amount of up to 95 wt.-%, preferably ranging from 40 to 90 wt.-%, more preferably ranging from 50 to 85 wt.-%, wherein the weight is based on the total weight of the molding composition.

### Component (B):

The molding composition of the present invention further comprises at least one plasticizer (B) (hereinafter also referred to as component (B)).

The plasticizer (B) is a substance incorporated into the composition of the invention to increase its flexibility. The plasticizer reduces the melt viscosity and decreases the elastic modulus of the molded parts obtainable from the composition of the invention. The plasticizers (B) which are useful for the molding composition are organic substances with low vapor pressures, which react physically with the components of the composition to form a homogeneous physical unit, whether it is by means of swelling or dissolving or any other. It has surprisingly found that an effective plasticizing effect could only be achieved in compositions which in addition to the polyoxymethylene (A) comprise at least one impact modifier (C), especially a thermoplastic elastomer.

Preferably the plasticizer (B) has a molecular weight ranging from 100 to 1000, more preferably 120 to 800 and especially 150 to 600 g/mol. However, in case of polymeric plasticizers, preferably polyesters, an average molecular weight ranging from 800 to 10000 g/mol is preferred. Especially preferred are polyesters having an average molecular weight ranging from 1000 to 7000 g/mol.

Further preferred are plasticizers (B) having a melting point of less than 200° C., preferably less than 180° C. Especially preferred are plasticizers which are liquid or have a solid amorphous phase within the range of −20° C. to 100° C.

According to a preferred embodiment the plasticizer (B) is selected from the group consisting of aromatic esters, aromatic polyesters, aliphatic diesters, epoxides, sulfonamides, glycols, polyethers, polybutenes, polyesters, acetylated monoglycerides, alkyl citrates and organophosphates and mixtures thereof.

Preference is given to plasticizers which comprise an ester functionality. Therefore according to a preferred embodiment the plasticizer (B) is selected from the group consisting of adipates, sebacates, maleates, phthalates, trimellitates, benzoates and mixtures thereof.

Examples of suitable phthalates are diisobutyl phthalate (DIBP), dibutyl phthalate (DBP), diisoheptyl phthalate (DIHP), L 79 phthalate, L711 phthalate, dioctyl phthalate, diisooctyl phthalate, dinonyl phthalate, diisononyl phthalate, diisodecyl phthalate, L911 phthalate, diundecyl phthalate, diisoundecyl phthalate, undecyl dodecyl phthalate, diisotridecyl phthalate (DTDP) and butyl benzyl phthalate (BBP).

Examples of adipates are dioctyl adipate, diisononyl adipate and diisodecyl adipate. An example for a trimellitate is trioctyl trimellitate. Phospate esters can also be used. Suitable examples are tri-2-ethylhexyl phosphate, 2-Ethylhexyl diphenyl phosphate and tricresyl phosphate.

Preferred sebacates and azelates are di-2-ethylhexyl sebacate (DOS) and di-2-ethylhexyl azelate (DOZ).

Preferred polyester plasticizers are typically based on condensation products of propane- or butanediols with adipic acid or phthalic anhydride. The growing polymer chain of these polyesters may then be end-capped with an alcohol or a monobasic acid, although non-end-capped polyesters can be produced by strict control of the reaction stoichiometry.

Further preferred plasticizers (B) are benzoates which are commercially available as Jayflex® MB10, Benzoflex® 2088, Benzoflex® LA-705, Benzoflex® 9-88. Epoxide based plasticizer are preferably epoxidized vegetable oils.

Especially preferred plasticizers (B) are aromatic benzene sulfonamides. Preference is given to benzene sulfonamides represented by the general formula (I)

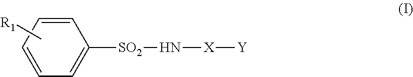

in which
R₁ represents a hydrogen atom, a C₁-C₄alkyl group or a C₁-C₄alkoxy group,
X represents a linear or branched C₂-C₁₀ alkylene group, or
a cycloaliphatic group, or
an aromatic group,
Y represents one of the groups OH or

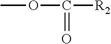

R₂ represents a C₁-C₄ alkyl group or an aromatic group, these groups optionally themselves being substituted by an OH or C₁-C₄alkyl group.

The preferred aromatic benzenesulphonamides of formula (I) are those in which:

R₁ represents a hydrogen atom or a methyl or methoxy group,
X represents a linear or branched C₂-C₁₀ alkylene group or a phenyl group,
Y represents an OH or —O—CO—R₂ group,
R₂ representing a methyl or phenyl group, the latter being themselves optionally substituted by an OH or methyl group.

Mention may be made, among the aromatic sulphonamides of formula (I) which are liquid (L) or solid (S) at room temperature as specified below, of the following products, with the abbreviations which have been assigned to them:
N-(2-hydroxyethyl)benzenesulphonamide (L),
N-(3-hydroxypropyl)benzenesulphonamide (L),
N-(2-hydroxyethyl)-p-toluenesulphonamide (S),
N-(4-hydroxyphenyl)benzenesulphonamide (S),
N-[(2-hydroxy-1-hydroxymethyl-1-methyl)ethyl]benzenesulphonamide (L),
N-[5-hydroxy-1,5-dimethylhexyl]benzenesulphonamide (S),
N-(2-acetoxyethyl)benzenesulphonamide (S),
N-(5-hydroxypentyl)benzenesulphonamide (L),
N-[2-(4-hydroxybenzoyloxy)ethyl]benzene-sulphonamide (S),
N-[2-(4-methylbenzoyloxy)ethyl]benzenesulphonamide (S),
N-(2-hydroxyethyl)-p-methoxybenzenesulphonamide (S) and
N-(2-hydroxypropyl)benzenesulphonamide (L).

The advantages introduced by the aromatic sulphonamides of formula (I) in the plasticization of the semi-crystalline polymers are many. Among these, mention may be made of:

The high thermal stability of the sulphonamides makes it possible to incorporate them in polymers at high temperature without them substantially evaporating, which prevents losses of the product and atmospheric pollution; they do not decompose at high temperature, which prevents unacceptable coloring of the polymer and allows them to act as plasticizer since they remain present intact in the polymer. It is consequently possible henceforth to use these plasticizers for processing techniques (injection molding, extrusion, extrusion blow-molding, rotational molding, and the like) at high temperatures and with long contact times, their high compatibility with the abovementioned polyoxymethylene (A) also promotes the development of their plasticizing properties, their plasticizing effect is reflected by a large decrease in the mechanical torque developed by the molten medium during mixing of the plasticizer with the polymer as well as during any processing of these compositions, which represents a large decrease in the energy to be used during these operations; the plasticizing effect is also reflected by a fall in the glass transition temperature, which results in a decrease in the stiffness of the articles obtained starting with these compositions, which can be measured by the fall in the elastic modulus and by an improvement in the impact strength.

An especially preferred plasticizer (B) is a sulfonamide, for example N-(n-butyl)benzene sulfonamide.

The plasticizer (B) is present in the composition preferably in an amount up to 40 wt.-%, such as ranging from 1 to 40 wt.-% or ranging from 3.5 wt.-% to 40 wt.-%, further preferably in an amount ranging from 2 to 30 wt.-% or 3.5 to 30 wt.-% or 5.5 to 30 wt.-%, more preferably ranging from 5 to 20 wt.-% or 5.5 to 20 wt.-% or 6.0 to 20 wt.-%, most preferably ranging from 8 to 18 wt.-%, wherein the weight is based on the total weight of the composition.

### Component (C):

The molding composition of the present invention further comprises at least one impact modifier (C) (hereinafter also referred to as component (C)).

Impact modifier are components which are added to and incorporated in the polyoxymethylene (A) matrix to improve the impact resistance of the finished product to resist sudden pulses or shocks. According to a preferred embodiment of the present invention the impact modifier (C) is a rubber or a thermoplastic elastomer.

Preference is given to molding compositions which comprise as the impact modifier (C) at least one thermoplastic elastomer (TPE) which is selected from the group consisting of thermoplastic copolyester elastomer (TPC), thermoplastic polyamide elastomer (TPA), thermoplastic polystyrene elastomer (TPS), thermoplastic polyolefine elastomer (TPO), thermoplastic polyurethane elastomer (TPU) and mixtures thereof. These thermoplastic elastomers usually have active hydrogen atoms which can be reacted with the coupling agent (D). Examples of such groups are urethane groups, amido groups, amino groups or hydroxyl groups, for example of terminal polyester diol flexible segments of thermoplastic polyurethane elastomers which have hydrogen atoms which can react, for example, with isocyanate groups. The presence of the coupling agent (D) is not essential but is preferred since the notched impact strength of the molded compositions can be further increased.

According to a further preferred embodiment the impact modifier (C) is a nitrile butadiene rubber or a core/shell impact modifier, preferably a polybutadiene core/polymethacrylate shell impact modifier.

Thermoplastic copolyesters are commercially available as Riteflex® 430, thermoplastic polyurethanes (TPU) are commercially available as Elastolan® B85A10. Thermoplastic vulcanizates and thermoplastic olefins which are crosslinked with rubber are commercially available as Lotader® AX8900 which is a terpolymer comprising the monomers ethylene, acrylic ester and glycidylmethacrylate. A nitrile butadiene rubber (NBR) is commercially available as Baymod® N34.52.

Core shell impact modifiers based on butadiene rubber are commercially available as Paraloid® EXL2600.

Especially good results could be achieved with thermoplastic polyurethanes (TPU).

In one particular embodiment, a thermoplastic polyurethane elastomer is used as the impact modifier either alone or in combination with other impact modifiers. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(ε-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate), wherein 4,4′-methylenebis(phenyl isocyanate) and 2,4-toluene diisocyanate are preferred. Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

According to a preferred embodiment the molding composition comprises the impact modifier in an amount of 3 to 30 wt.-%, preferably 5 to 20 wt.-%, more preferably 10 to 20 wt.-%, wherein the weight is based on the total weight of the composition.

### Component (D):

The molding composition preferably additionally comprises at least one coupling agent (D) (herein after also referred to as component (D)).

The coupling agent provides a linkage between the nucleophilic groups in the molding composition. Preferably polyfunctional, such as trifunctional or bifunctional coupling agents may be used. According to a preferred embodiment the coupling agent (D) is a diisocyanate or triisocyanate selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexa methylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane tri isocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methyl hexane, 1,6-diisocyanato-2,4,4-tetra-trimethyl hexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

According to further preferred embodiment the coupling agent (D) is selected from the group consisting of derivatives of carbonic acid, especially carbonic acid ester, activated urea derivatives, ester or half ester of dicarboxylic acids, dianhydrides, diimides and mixtures thereof.

Especially preferred are aromatic polyisocyanates, such as 4,4′-diphenylmethane diisocyanate (MDI).

Preferably, the molding composition of the present invention comprises the coupling agent (D) in an amount ranging from 0.1 to 5 wt.-%, further preferably ranging from 0.2 to 3 wt.-% and more preferably ranging from 0.4 to 2.5 wt.-%, wherein the weight is based on the total weight of the composition.

The reaction of the components is typically effected at temperatures of from 100 to 240° C., such as from 150 to 220° C., and the duration of mixing is typically from 0.25 to 60 minutes.

The molding materials or moldings according to the invention can optionally be stabilized and/or modified by known additives. Such stabilizers and processing auxiliaries used as optional component (E) are known to the person skilled in the art.

These stabilizers are, for example, antioxidants, acid scavengers, UV stabilizers or heat stabilizers. In addition, the molding material or the molding may contain processing auxiliaries, for example a promoter, lubricants, nucleating agents, demolding agents, filler, or antistatic agents and additives which impart a desired property to the molding material or to the molding, such as dyes and/or pigments and/or formaldehyde scavengers and/or additives imparting electrical conductivity and mixtures of these additives, but without limiting the scope to said examples.

Component (E) can be present in the molding composition in an amount up to 10 wt.-%, preferably from 0.1 to 5 wt.-%, especially 0.2 to 2 wt.-% based on the total weight of the molding composition.

According to a preferred embodiment the molding composition of the invention has a Charpy Notched Impact Strength (CNI) at 23° C., determined according to ISO 179-1/1eA (CNI), of higher than 10 kJ/m², preferably higher than 15 kJ/m², more preferably ranging from 10 to 40 kJ/m², even more preferably ranging from 18 to 40 kJ/m².

The molding composition further preferably has an E-modulus, determined according to ISO 527, of less than 1500 MPa, preferably ranging from 500 to 1500 MPa, more preferably ranging from 500 to 1000 MPa.

The molding composition of the invention preferably has an elongation at yield, determined according to ISO 527, of higher than 15%, further preferably higher than 20%, more preferably ranging from 15 to 80%, even more preferably ranging from 20 to 45%.

Preference is given to a composition which has an elongation at break, determined according to ISO 527, of higher than 50%, preferably ranging from 90 to 500%, more preferably ranging from 90 to 500%.

The composition of the invention is preferably adjusted to have a melt volume rate (MVR) of less than 5 cm³/10 min, preferably less than 4 cm³/10 min, more preferably ranging from 0.5 to 5 cm³/10 min and especially ranging from 0.5 to 3.5 cm³/10 min, determined according to ISO 1133 at 190° C. and 2.16 kg.

Especially preferred is a molding composition comprising

a) at least one polyoxymethylene (A),
b) at least 1 wt.-% of at least one plasticizer (B),
c) at least one impact modifier (C) and
d) optionally at least one coupling agent (D);

wherein the composition is characterized by
a melt volume rate (MVR) of less than 5 cm³/10 min, determined according to ISO 1133 at 190° C. and 2.16 kg,
a Charpy Notched Impact Strength (CNI) at 23° C., determined according to ISO 179-1/1eA (CNI) of higher than 10 kJ/m², more preferably ranging from 10 to 40 kJ/m²,
has an E-modulus of less than 1500 MPa, preferably ranging from 500 to 1000 MPa, determined according to ISO 527,
an elongation at yield of higher than 15%, preferably ranging from 20 to 60% determined according to ISO 527 and
an elongation at break of higher than 50%, preferably ranging from 90 to 500%, determined according to ISO 527.

A preferred embodiment of the composition of the present invention comprises
a) a polyoxymethylene (A) having a MVR (190° C., 2.16 kg) ranging from 1 to 9 cm³/10 min and a portion of terminal OH groups of more than 5, preferably ranging from 15 to 50 mmol/kg,
b) at least one plasticizer (B) selected from the group consisting of aromatic ester and aromatic sulfonamides,
c) at least one impact modifier (C) selected from the group consisting of thermoplastic elastomers and rubber, preferably a thermoplastic polyurethane elastomer (TPU); and
d) optionally a coupling agent (D) which is an aromatic polyisocyanate, preferably an aromatic diisocyanate.

It has been found that the molded parts which are obtainable by molding the molding composition of the invention show an excellent flexibility while having a high impact resistance and additionally have a good pressure resistance. A further embodiment is therefore a molded part obtainable by molding a molding composition of the present invention.

The molded parts have the same mechanical properties as determined above in conjunction with the molding composition.

Preferably the molded part is obtainable by a molding technique selected from the group consisting of injection molding, extrusion, blow molding, deep drawing and extrusion blow molding for the manufacturing of corrugated pipes.

The molding of the molding composition is usually carried out of temperatures higher than 120° C., preferably 160° C. to 220° C. for the manufacturing of molded parts used in the automotive industry, especially for the manufacturing of compression-loaded molded parts.

In one embodiment, the molding composition of the present disclosure is reacted together and compounded prior to being used in a molding process. For instance, in one embodiment, the different components can be melted and mixed together in a conventional single or twin screw extruder at a temperature described above. Extruded strands may be produced by the extruder which are then pelletized. Prior to compounding, the polymer components may be dried to a moisture content of about 0.05 weight percent or less. If desired, the pelletized compound can be ground to any suitable particle size, such as in the range of from about 100 microns to about 500 microns.

A further embodiment is the use of the molding composition or molded parts of the invention for cables, pipes, tubes, corrugated pipes, fuel pipes, air pipes, fuel hoses, brake hoses, air hoses, hydraulic hoses, pneumatic hoses, pressure hoses and connection assemblies.

According to an especially preferred embodiment of the present invention the molded part is a tube or hose, preferably a corrugated tube. Preferably the polymer tubing is corrugated in at least one partial section and the rings formed by the corrugation extend around the tube access. The corrugated tubes according to the present invention have a high degree of flexibility and bursting pressure resistance. A field of application of the tube in accordance with the present invention are coolant lines used in automobile manufacturing, e.g. for air condition and/or radiator lines. Additionally, the tubes according to the present invention have an excellent fuel resistance and can therefore be used in fuel pipes, especially in the automobile manufacturing. The corrugated tubing in accordance with the present invention can be produced by co-extrusion of the molding composition to obtain a pipe and subsequent formation of the corrugation, which may include flattenings, by means of blow or aspiration molding. The tubing according to the present invention can alternatively produced by means of extrusion or co-extrusion or blow molding, or sequential blow molding with or without pipe manipulation.

These processes are state of the art and have been described among others, in DE 9319190 U1 and DE 9319879 U1.

In connection with its use as a coolant line, the tubing in accordance with the invention which can be charged with pressure, comprises at least one polymer layer which consists of the molded composition of the present invention. Further, preferably at least a partial portion of the tubing is corrugated and wherein the rings formed by the corrugations extend concentrically around the tube access.

In connection with gasoline filler necks it is preferred that the corrugated tubing has areas of great stretching ability and areas with reduced stretching ability in addition to great flexibility.

Since the tubing according to the present invention has advantages over prior art corrugated tubings in connection with pressurized systems as well as systems with underpressure, the tubing in accordance with the invention can preferably also be used in underpressure systems, such as air supply lines, e.g. in the engine inlet area.

The following examples illustrate the invention.

### EXAMPLES

The following components were used in the examples:

### POM A:

Polyacetal containing 3.4 wt.-% of comonomer dioxolane with an MVR (190° C./2.16 kg) of 7.9 cm³/10 min and a portion of terminal OH-groups of 6-10 mmol/kg

### POM B:

Polyacetal containing 3.4 wt.-% of comonomer dioxolane with an MVR (190° C./2.16 kg) of 8.3 cm³/10 min and a proportion of terminal OH groups of 20-25 mmol/kg

### POM C:

Polyacetal containing 3.4 wt.-% of comonomer dioxolane with an MVR (190° C./2.16 kg) of 1.8 cm³/10 min and a portion of terminal OH groups of 6-10 mmol/kg

### POM D:

Polyacetal containing 3.4 wt.-% of comonomer dioxolane with an MVR (190° C./2.16 kg) of 1.9 cm³/10 min and a portion of terminal OH groups of 20-25 mmol/kg

### POM E:

Polyacetal containing 3.4 wt.-% of comonomer dioxolane with an MVR (190° C./2.16 kg) of 2.4 cm³/10 min and a proportion of terminal OH groups of 20-25 mmol/kg

BBSA: plasticizer: N-(n-butyl)benzene sulfonamide

MDI: coupler: Methylenediphenyl-4,4′ diisocyanate (MDI)

All components were mixed in a Dirk and Soehne mixer (model Diosna R10A). For the compounding, an extruder from Coperion (MEGAcompounder ZSK 25) was used (zone temperatures all 190° C., melt temperature about 210° C.). The screw configuration with kneading elements was chosen so that effective thorough mixing of the components took place during the extrusion.

Unless indicated otherwise all determinations have been carried out at room temperature (23° C.).

The testing of the prepared molding compositions was affected according to the following standards:

Melt volume rate (MVR) (190° C.; 2.16 kg): ISO 1133;

Charpy notched impact strength: ISO 179-1/1eA (CNI);

Elongation at break, E-modulus (tensile modulus) and elongation at yield have been determined according to ISO 527;

Portion of terminal OH groups in POM has been determined as described in K. Kawaguchi, E. Masuda, Y. Tajima, Journal of Applied Polymer Science, Vol. 107, 667-673 (2008).

TABLE A
Comparative examples showing mixtures of POM and plasticizer

| | | CNI @ | | | | |
|---|---|---|---|---|---|---|
| POM/ | BBSA | 23° C. | E-Modulus | Elongation @ | Elong. @ | MVR [cm³/ |
| wt.-% | [wt.-%] | [kJ/m²] | [MPa] | Yield [%] | Break [%] | 10 min] |
| POM A/100 | 0 | 6.1 | 2900 | 8.6 | 36.7 | 9.9 |
| POM A/95 | 5 | 7.7 | 2100 | 10.9 | 57.6 | 11.6 |
| POM A/90 | 10 | 6.0 | 1650 | 12.6 | 67.8 | 14.8 |
| POM A/85 | 15 | 5.0 | 1300 | 14.6 | 58.4 | 19.8 |
| POM C/100 | 0 | 8.0 | 2550 | 9.2 | 34.1 | 5.2 |
| POM C/95 | 5 | 10.2 | 1850 | 11.6 | 66.2 | 5.2 |
| POM C/90 | 10 | 7.2 | 1400 | 13.6 | 94.2 | 5.8 |
| POM C/85 | 15 | 7.1 | 1150 | 15.7 | 162.8 | 7.2 |

Table B shows molding compositions which comprise a polyoxymethylene, an impact modifier (TPU, Elastollan® B85A10) and the plasticizer BBSA. The amounts are in weight-%, based on the weight of the total composition.

TABLE B

| | | Impact | | | | | | |
|---|---|---|---|---|---|---|---|---|
| | | modifier | | CNI@ | E- | Elong. | Elong. | MVR |
| | POM/ | (TPU) | BBSA | 23° C. | Modulus | @ Yield | @ Break | [cm³/ |
| Ex. | wt.-% | [wt.-%] | [wt.-%] | [kJ/m²] | [MPa] | [%] | [%] | 10 min] |
| 1 | POM A/100 | 0 | 0 | 6.1 | 2900 | 8.6 | 36.7 | 9.9 |
| 2 | POM A/95 | 0 | 5 | 7.7 | 2100 | 10.9 | 57.6 | 11.6 |
| 3 | POM A/90 | 0 | 10 | 6.0 | 1650 | 12.6 | 67.8 | 14.8 |
| 4 | POM A/85 | 0 | 15 | 5.0 | 1300 | 14.6 | 58.4 | 19.8 |
| 5 | POM A/82 | 18 | 0 | 12.9 | 1800 | 12.7 | 87.9 | 7.4 |
| 6 | POM A/77 | 18 | 5 | 12.1 | 1250 | 16.8 | 91.2 | 9.6 |
| 7 | POM A/72 | 18 | 10 | 10.4 | 950 | 19.9 | 228.2 | 11.6 |
| 8 | POM A/67 | 18 | 15 | 12.7 | 750 | 23.2 | 227.8 | 16.3 |

Examples 1 to 5 are comparative examples.

Table C shows the impact of different POM in compositions comprising MDI as coupling agent, BBSA as plasticizer and TPU (Elastollan® B85A10) as impact modifier. The amounts are in wt.-%, based on the total weight of the composition.

TABLE C

| | | MDI | TPU | BBSA | CNI @ | E-Modulus | Elong. @ | Elong. @ | MVR @ 190° C./2.16 kg |
|---|---|---|---|---|---|---|---|---|---|
| Ex. | POM/wt.-% | [wt.-%] | [wt.-%] | [wt.-%] | 23° C. [kJ/m²] | [MPa] | Yield [%] | Break [%] | [cm³/10 min] |
| 9 | POM C/66.5 | 0.5 | 18 | 15 | 28.2 | 700 | 31.5 | 240 | 3.7 |
| 10 | POM D/66.5 | 0.5 | 18 | 15 | 23.2 | 700 | 31.8 | 244 | 2.8 |
| 11 | POM D/65.5 | 1.5 | 18 | 15 | 24.3 | 700 | 28.2 | 264 | 1.2 |
| 12 | POM B/66.5 | 0.5 | 18 | 15 | 18.1 | 750 | 23.2 | 120 | 8.2 |

Table D shows the impact of various impact modifiers (18 wt.-%) in a composition comprising BBSA as plasticizer and MDI as coupling agent

TABLE D

| | | MDI | Impact | BBSA | CNI @ 23° C. | E-Modulus | Elong. @ | Elong. @ | MVR @ 2.16 kg |
|---|---|---|---|---|---|---|---|---|---|
| Ex. | POM/wt.-% | [wt.-%] | modifier | [wt.-%] | [kJ/m²] | [MPa] | Yield [%] | Break [%] | [cm³/10 min] |
| 13 | POM E/66.5 | 0.5 | Elastollan ® | 15 | 21.4 | 700 | 30.7 | 237 | 3.3 |
| | | | B85A10¹⁾ | | | | | | |
| 14 | POM E/66.5 | 0.5 | Riteflex ® | 15 | 12.6 | 800 | 24.1 | 169 | 4.9 |
| | | | 430²⁾ | | | | | | |
| 15 | POM E/66.5 | 0.5 | Lotader ® | 15 | 6.4 | 800 | 22.9 | 93 | 7.5 |
| | | | AX 8900³⁾ | | | | | | |
| 16 | POM E/65.5 | 1.5 | Baymod ® | 15 | 12.8 | 800 | 18.3 | 92 | 2.5 |
| | | | N 34.52⁴⁾ | | | | | | |
| 17 | POM E/66.5 | 0.5 | Paraloid ® | 15 | 14.5 | 650 | 33.2 | 68 | 1.4 |
| | | | EXL 2600⁵⁾ | | | | | | |

¹⁾thermoplastic polyurethane elastomer (TPU)
²⁾thermoplastic copolyester elastomer (TPC)
³⁾terpolymer of ethylene, acrylic ester and glycidyl methacrylate
⁴⁾nitrile butadiene rubber (NBR)
⁵⁾core/shell impact modifier based on butadiene rubber

Table E shows the influence of the impact modifier and plasticizer content on the mechanical properties.

TABLE E

| | POM/ | MDI | TPU | BBSA | CNI@23° C. | E-Modulus | Elong. @ | Elong. | MVR @ 2.16 kg |
|---|---|---|---|---|---|---|---|---|---|
| Ex. | wt.-% | [wt.-%] | [wt.-%] | [wt.-%] | [kJ/m²] | [MPa] | Yield [%] | @ Break [%] | [cm³/10 min] |
| 18 | POM D/88.5 | 0.5 | 6 | 5 | 17.6 | 1500 | 15.1 | 69 | 1.6 |
| 19 | POM D/76.5 | 0.5 | 18 | 5 | 32.1 | 1100 | 24.1 | 340 | 0.8 |
| 20 | POM D/78.5 | 0.5 | 6 | 15 | 13.7 | 900 | 20.6 | 337 | 3.6 |
| 21 | POM D/66.5 | 0.5 | 18 | 15 | 27.8 | 700 | 35.0 | 404 | 2.7 |
| 22 | POM D/77.5 | 0.5 | 12 | 10 | 21.3 | 1000 | 22.8 | 306 | 2.1 |

Table F shows the influence of different plasticizers (15 wt.-%), amount of coupling agent (MDI) and amount of impact modifier (TPU) on the mechanical properties, based on POM D. The amounts are based on the total weight of the composition.

TABLE F

| | | MDI | TPU | CNI@23° C. | E-Modulus | Elong. @ | Elong. | MVR @ 2.16 kg |
|---|---|---|---|---|---|---|---|---|
| Ex. | Plasticizer | [wt.-%] | [wt.-%] | [kJ/m²] | [MPa] | Yield [%] | @ Break [%] | [cm³/10 min] |
| 23 | BBSA | 0 | 6 | 9.0 | 950 | 17.4 | 70.3 | 4.6 |
| 24 | BBSA | 1 | 6 | 13.4 | 1000 | 15.9 | 86.9 | 3.1 |
| 25 | BBSA | 0 | 18 | 14.4 | 700 | 29.0 | 109.8 | 5.6 |
| 26 | BBSA | 1 | 18 | 23.7 | 750 | 25.8 | 357.5 | 2.4 |
| 27 | BBSA | 0.5 | 12 | 14.0 | 850 | 21.7 | 253.4 | 3.4 |
| 28 | MB10¹⁾ | 0 | 6 | 10.2 | 1100 | 19.3 | 61.1 | 4.9 |
| 29 | MB10¹⁾ | 1 | 6 | 23.2 | 1200 | 17.0 | 84.5 | 1.9 |
| 30 | MB10¹⁾ | 0 | 18 | 14.1 | 700 | 38.6 | 75.1 | 6.6 |
| 31 | MB10¹⁾ | 1 | 18 | 55.8 | 800 | 33.9 | 458.2 | 1.3 |
| 32 | MB10¹⁾ | 0.5 | 12 | 19.3 | 950 | 26.7 | 288.4 | 1.8 |

¹⁾Jayflex MB10: isodecyl benzoicacid ester

Table G shows comparative examples 34 and 35 wherein aromatic light stabilizers as mentioned in EP 350 223 A2 are used. TPU Elastollan® B95A11 is used as impact modifier. The amounts are based on the total weight of the composition

TABLE G

| | | MDI | | | | CNI @ | | Elong. @ | Elong. @ | MVR @ |
|---|---|---|---|---|---|---|---|---|---|---|
| | POM/ | [wt.- | | | Plasticizer | 23° C. | E-Modulus | Yield | Break | 2.16 kg |
| Ex. | wt.-% | %] | TPU [wt. %] | Plasticizer | [wt. %] | [kJ/m²] | [wt. %] | [%] | [%] | [cm³/10 min] |
| 33 | POM E/ | 1 | 20 | BBSA | 3 | 21.0 | 1300 | 18.4 | 81 | 0.3 |
| | 66.0 | | | | | | | | | |
| 34 | POM E/ | 1 | 20 | 2,4-Di-t- | 3 | 18.0 | 1600 | 16.2 | 68 | 0.1 |
| | 66.0 | | | butylphenyl-3,5- | | | | | | |
| | | | | di-t-butyl-4- | | | | | | |
| | | | | hydroxybenzoate¹⁾ | | | | | | |
| 35 | POM E/ | 1 | 20 | Hexadecyl-3,5- | 3 | 18.8 | 1550 | 19.9 | 83 | 0.1 |
| | 66.0 | | | di-t-butyl-4- | | | | | | |
| | | | | hydroxybenzoate²⁾ | | | | | | |

¹⁾ and ²⁾are light stabilizer

1. A molding composition comprising
a) at least one polyoxymethylene (A),
b) at least 1 wt.-% of at least one plasticizer (B),
c) at least one impact modifier (C), and
d) at least one coupling agent (D)
wherein the composition has an E-modulus (determined according to ISO 527) of less than 1500 MPa.

2. A molding composition comprising
a) at least one polyoxymethylene (A),
b) 3.5 to 40 wt.-% of at least one plasticizer (B),
c) at least one impact modifier (C); and
d) at least one coupling agent (D).

3. A molding composition according to claim 1, wherein at least 25%, preferably at least 50% and more preferably at least 75% of the terminal groups of the polyoxymethylene (A) are hydroxyl groups, especially hydroxyethylene groups.

4. A molding composition according to claim 1, wherein the polyoxymethylene (A) comprises at least 50 mol-%, preferably at least 70 mol-%, more preferably at least 85 mol-% and most preferably at least 95 mol-% of —CH₂O— repeat units.

5. A molding composition according to claim 1, wherein the coupling agent (D) is a polyisocyanate, preferably an organic diisocyanate, more preferably selected from the group consisting of aliphatic diisocyanates, cycloaliphatic diisocyanates, aromatic diisocyanates and mixtures thereof.

6. A molding composition according to claim 1, wherein the coupling agent (D) is present in an amount ranging from 0.1 to 5 wt.-%, preferably ranging from 0.2 to 3 wt.-% and more preferably ranging from 0.4 to 2.5 wt.-%, wherein the weight is based on the total weight of the composition.

7. A molding composition according to claim 1, wherein the impact modifier (C) is thermoplastic elastomer selected from the group consisting of thermoplastic copolyester elastomer (TPC), thermoplastic polyamide elastomer (TPA), thermoplastic polystyrene elastomer (TPS), thermoplastic polyolefin elastomer (TPO), thermoplastic polyurethane elastomer (TPU) and mixtures thereof.

8. A molding composition according to claim 1, wherein the impact modifier (C) is present in an amount of 3 wt.-% to 30 wt.-%, preferably 5 wt.-% to 20 wt.-%, more preferably 10 to 20 wt.-%, wherein the weight is based on the total weight of the composition.

9. A molding composition according to claim 1, wherein the plasticizer (B) is an aliphatic or aromatic ester, preferably selected from the group consisting of adipates, sebacates, maleates, phthalates, trimellitates, benzoates and mixtures thereof.

10. A molding composition according to claim 1, wherein the plasticizer (B) is a sulfonamide, preferably N-(n-butyl)benzene sulfonamide.

11. A molding composition according to claim 1, wherein the plasticizer (B) is present in the composition in an amount ranging from 1 to 40 wt.-%, preferably in an amount ranging from 2 to 30 wt.-%, more preferably ranging from 5 to 20 wt.-%, most preferably ranging from 8 to 18 wt.-%, wherein the weight is based on the total weight of the composition.

12. A molding composition comprising
a) at least one polyoxymethylene (A),
b) at least 1 wt.-% of at least one plasticizer (B),
c) at least one impact modifier (C) and
d) optionally at least one coupling agent (D);
wherein the composition is characterized by
a melt flow index (MVR) of less than 5 cm³/10 min, determined according to ISO 1133 at 190° C. and 2.16 kg and/or
a Charpy Notched Impact Strength (CNI) at 23° C., determined according to ISO 179-1/1eA (CNI), of higher than 10 kJ/m² and/or
has a tensile modulus, determined according to ISO 527, of less than 1500 MPa and/or
an elongation at yield, determined according to ISO 527, of higher than 15% and/or
an elongation at break, determined according to ISO 527, of higher than 50%.

13. Molded part obtainable by molding a molding composition according to claim 12.

14. Molded part according to claim 13 obtainable by a molding technique selected from the group consisting of injection molding, extrusion, blow molding, deep drawing and extrusion blow molding, e.g. for the manufacture of corrugated pipes.

15. (canceled)

16. A molded part according to claim 13 wherein the molded part comprises cables, pipes, tubes, corrugated pipes, fuel pipes, air pipes, fuel hoses, brake hoses, air hoses, hydraulic hoses, pneumatic hoses, pressure hoses and connection assemblies.
